(19) United States
(12) Patent Application Publication
(10) Pub. No.: US 2006/0010475 A1
(43) Pub. Date: Jan. 12, 2006

(54) High-spectrum radio frequency wireless transmission and control system for audio/video equipment

(76) Inventor: NingJun Sun, Chino, CA (US)

Correspondence Address: LAW OFFICES OF J.F. LEE, 17800 CASTLETON STREET, SUITE 383, CITY OF INDUSTRY, CA, 91748, US

(21) Appl. No.: 10/710,393

(22) Filed: Jul. 7, 2004

(51) Int. Cl. H04N 7/18

(52) U.S. Cl. 725/81

(57) ABSTRACT

A kind of high-spectrum radio frequency wireless transmission and control system is disclosed for used on audio/video equipment. By integrating a signal pick-up unit and a high-spectrum radio frequency transmission unit to a signal master source containing individual content source such as a DVD player, there is no longer any need to use signal wires for connecting the signal output from a DVD player to a TV, or multiple TVs, that are equipped with the same transceiver circuit to operate in the same frequency bandwidth. Installation of home theatres and exhibition TV-walls can be made simpler and less expensive by utilizing present invention.

### BACKGROUND OF INVENTION

The present invention relates generally to design and construction of wireless transmission of audio/video (“A/V”) signal from an A/V source, such as a DVD Player, using the high-spectrum area in the radio frequency, in the range of 1.8 G Hertz to 6.0 G Hertz, to transmit A/V signal to a receiving (playback) device, such as a TV set, without the need for wires.

### SUMMARY OF INVENTION

Present invention provides a system and construction of connecting A/V signal sources, such as a DVD player, to a receiving device, such as TV set, so that consumers can enjoy the A/V content at the receiving end, without using wires.

The use of present invention will simplify the assembly of a home A/V system since there is no need to connect any wires. By reducing the need for the presence of wires to carry the A/V signal, implementation of larger-scale image display, such as TV-wall type advertisement in trade shows and business exhibitions, is made substantially easier, and therefore, more cost-effective to build.

### BRIEF DESCRIPTION OF DRAWINGS

The accompanying drawings, which are incorporated in and constitute a part of this specification, illustrate the preferred embodiment of the invention and together with the description, serve to explain the principles of the invention.

A brief description of the drawings is as follows:

FIG. 1 shows the practical illustration of using present invention when multiple TVs can receive A/V content from a same source, such as a DVD player, without any signal wirings.

FIG. 2 shows the block diagram of an A/V content source, referred to as main unit, containing DVD player, VCR, or other A/V content generation machinery.

FIG. 3 shows the block diagram of A/V signal pick-up and control circuit.

FIG. 4 shows the block diagram of the high-spectrum radio frequency transmission circuit.

### DETAILED DESCRIPTION

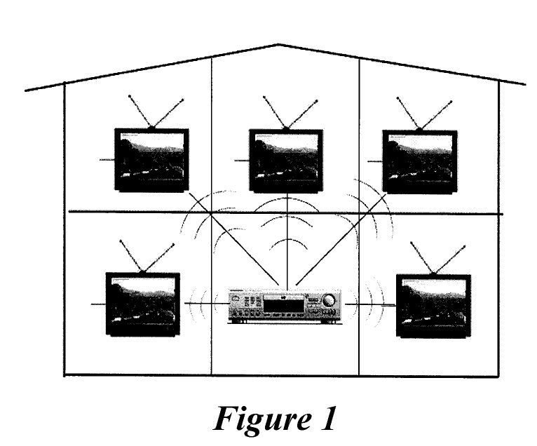

In FIG. 1, an A/V signal source, such as a DVD player, or other equipments such as VCR, TV/CATV Tuner, is connected to multiple TVs without using cables or wires, by following the teachings of present invention.

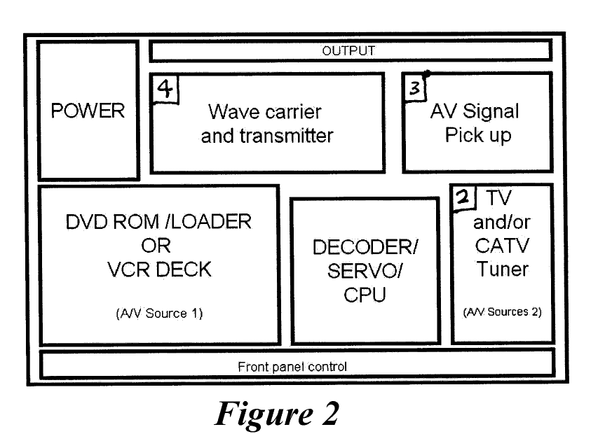

In FIG. 2, a block diagram of a signal source is shown being packaged in a Main Unit which contains DVD player, VCR, TV and/or CATV Tuner.

In FIG. 2, the block denoting DECODER, CPU, SERVER represents an A/V unit whatever the case may be. For example, a desktop computer may have a DVD player controlled by its CPU.

In FIG. 2, the block denoting POWER is the power supply unit. The power supply unit is a common prior art and can be built easily and thus not claimed by present invention. The FRONT PANEL CONTROL can be implemented by individual manufacturer to reflect different styles and is not a novel feature claimed by present invention.

In FIG. 2, the A/V source can even be another TV or other CATV Tuner that will re-transmit the A/V signal out to other TVs, as shown in the #2 Block.

In FIG. 2, the OUTPUT portion contains the traditional A/V connector ends (color-coded Yellow/Red/White) for wiring purposes and can be implemented by manufactures without further disclosure herein.

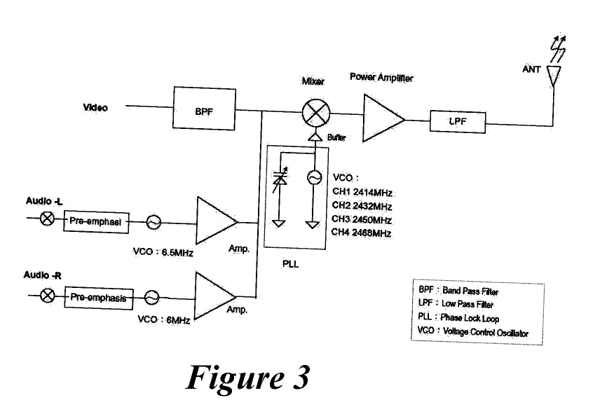

In FIG. 2, the blocks denoting AV SIGNAL PICK UP (#3) and WAVE CARRIER AND TRANSMITTER (#4) are novel features of present invention. Block 3, its details shown in FIG. 3, serves to pick up the A/V signal content from the source and send same to Block 4, which will then modulate the content to be carried on the radio frequency in the range of 1.8-6.0 G Hertz.

In FIG. 3, audio signals are picked up, and processed by voltage controlled oscillator (VCO) and are thereafter amplified, and then are combined with the picked up video signals. The combined signals are mixed to a carrier wave to be transmitted. The components identified as BPF, LPF, PLL, VCO, Mixer and Power Amplifier, are standard off-the-shelf products.

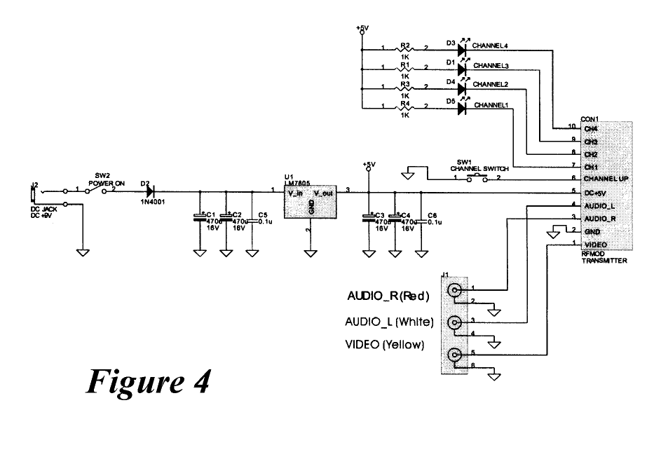

In FIG. 4, high-spectrum radio frequency transmission circuit is shown. The carrier wave is set to operate in the range of 1.8 -6.0 G Hertz to transmit the modulated signal picked up from FIG. 3. The transmitting power is subject to regulations of different countries regarding radio transmission intensity.

It is common knowledge in the radio technology field that the circuit for receiving radio signal is substantially the same as the transmitting circuit. The disclosure for the circuitry on the receiving end is thus not necessary and can be practiced by people reasonably skilled in the art.

Additionally, a RF (radio frequency) remote control can be used to control the individual content source in the Main Unit, so that consumers in different rooms or any place not directly in a line-of-sight spot from the Main Unit can still control the playback of the content source to the receiving end. Said RF remote control is commonly known technology and has widely available components; no further detail description is needed herein.

1. High-spectrum radio frequency wireless transmission and control system for audio/video equipment, comprising:
a. An audio/video signal master source;
b. An A/V signal pick-up and control circuit built into the unit of said signal master source;
c. A high-spectrum radio wave transmission and carrier circuit, operating in the radio frequency range between 1.8 G Hertz and 6.0 G Hertz, built into the unit of said signal master source, for modulating said picked-up A/V signal and for transmitting the content in said frequency range; and
d. A corresponding radio wave receiver unit built into one or a plurality of A/V playback machines.

2. The transmission and control system of claim 1, wherein said radio wave transmission and receiver circuits contain the frequency-hopping means defined by the industry standard to avoid near-range conflict.

3. The transmission and control system of claim 2, wherein said playback machine is a TV.

4. The transmission and control system of claim 2, wherein said audio/video signal master source contains DVD player, VCR, or TV, or all of said individual sources.

5. The transmission and control system of claim 3, wherein said A/V master source further contains a RF (radio frequency) remote control so that users can control the content playback in different places away from the master source.
